(19) United States
(12) Patent Application Publication
(10) Pub. No.: US 2025/0266770 A1
(43) Pub. Date: Aug. 21, 2025

(54) Flyback Converter Circuit and Electronic Device

(71) Applicant: HUAYUAN SEMICONDUCTOR (SHENZHEN) LIMITED COMPANY, Shenzhen (CN)

(72) Inventors: Haibin Xiao, Shenzhen (CN); Mingui Qin, Shenzhen (CN); Chunming Guo, Shenzhen (CN); Yubo Qiao, Shenzhen (CN)

(21) Appl. No.: 19/182,662

(22) Filed: Apr. 18, 2025

(51) Int. Cl. H02M 3/335

(52) U.S. Cl. CPC H02M 3/33576

(57) ABSTRACT

Provided are a flyback converter circuit and an electronic device. The first end of the second GaN switching transistor of the circuit is coupled to the first switching transistor and the end of the primary winding, and its second end is coupled to another end of the primary winding via the second resistor connected in parallel. The first voltage divider resistor and the second voltage divider resistor are connected in series to obtain the voltage output by the auxiliary winding and transmit the corresponding second signal. By controlling the turning on and off of the second GaN switching transistor, the stored energy of the primary winding's leakage inductance is transferred to the secondary winding before the first switching transistor turns on. The first switching transistor is controlled to turn on only when the second GaN switching transistor is turned off and the second signal indicates a fall through zero.

### CROSS REFERENCE TO RELATED APPLICATIONS

The present application claims the benefit of Chinese Patent Application No. 202410181174.6 filed on Feb. 18, 2024, the contents of which are incorporated herein by reference in their entirety.

### TECHNICAL FIELD

The application relates to the field of flyback circuits, in particular to a flyback converter circuit and an electronic device.

### BACKGROUND

In current flyback circuits, due to the incomplete coupling of the primary and secondary windings of the transformer, there is always leakage inductance in the circuit, which reduces the conversion efficiency of the circuit. Furthermore, as the output load of the circuit becomes heavier, the spike voltage generated by the leakage inductance becomes higher, leading to issues such as EMI (Electro-Magnetic Interference) and voltage stress. In ordinary flyback circuits, there is also a significant capacitive turn-on loss when the main switching transistor is turned on. Even in the QR (Quasi-Resonant) flyback mode, when the input voltage is much higher than N*Vo (where N=Np/Ns), the valley voltage remains high, and the main switching transistor still experiences significant turn-on losses.

The current solution involves adding an auxiliary MOS switch, which operates in a complementary state to the main switching transistor on the primary side of the circuit. The auxiliary MOS switch is configured to turn on for a fixed period before the main switching transistor turns on, so that when the main switching transistor turns off, the energy of the leakage inductance is first absorbed into a clamp capacitor, and then released to the load or input terminal. However, this approach results in the time required to turn the auxiliary MOS switch on and off being a large fixed value, which will lead to a large effective current value of the auxiliary MOS switch and a large conduction loss, reducing the efficiency of the circuit. Moreover, due to the long reverse recovery time of the body diode of the auxiliary MOS and the large reverse recovery current (the reverse recovery time and current being much larger than that of GaN), there is a common risk associated with reverse recovery during CCM (Continuous Conduction Mode) operation, which reduces the reliability of the circuit.

Therefore, ensuring that the main switching transistor can turn on at zero voltage, recovering the transformer's leakage inductance energy, while improving both the efficiency and reliability of the circuit, has become a pressing technical issue in the industry that needs to be addressed.

### SUMMARY OF THE INVENTION

The present application provides a flyback converter circuit and an electronic device to address the challenge of ensuring that the main switching transistor turns on under zero voltage, recovering the leakage inductance energy of the transformer, while also improving circuit efficiency and reliability.

In one aspect, the present application provides a flyback converter circuit, including: a primary-side input circuit, a transformer, a secondary-side output circuit, and an auxiliary winding circuit; wherein the primary-side input circuit includes a switching transistor control unit, a first switching transistor, and an absorption module; the auxiliary winding circuit includes a first voltage divider resistor, a second voltage divider resistor, a first capacitor, and a first resistor; the absorption module includes a second resistor, a second capacitor, and a second GaN (gallium nitride) switching transistor;
a first input terminal of the switching transistor control unit receives a first signal, a second input terminal receives a switching frequency clock control signal, and an output terminal is coupled to a control terminal of the first switching transistor and a control terminal of the second GaN switching transistor, respectively; a first end of the first switching transistor is coupled to both a first end of the primary winding and a first end of the second GaN switching transistor, while a second end of the second GaN switching transistor is coupled to both a first end of the second resistor and a first end of the second capacitor; a second end of the second resistor and a second end of the second capacitor are coupled to a second end of the primary winding; wherein the first signal includes current information flowing through the first end of the second GaN switching transistor;
a first end of the auxiliary winding is coupled to both a first end of the first voltage divider resistor and a first end of the first capacitor; a second end of the first voltage divider resistor is coupled to a first end of the second voltage divider resistor, and the second end of the first voltage divider resistor is also coupled to the a input end of the switching transistor control unit to output a second signal; a second end of the second voltage divider resistor is coupled to both a second end of the auxiliary winding and a second end of the first capacitor, and the first resistor is connected in parallel with the first capacitor; wherein the second signal includes a current value flowing through the first voltage divider resistor or a voltage value at the second end of the first voltage divider resistor;
a first end and a second end of the secondary winding are coupled to a first end and a second end of the secondary-side output circuit, respectively;
wherein the switching transistor control unit is configured to:
control the turning on and off of the second GaN switching transistor based at least on the switching frequency clock control signal, the first signal, and an operating mode of the flyback converter circuit, so as to transfer stored energy of the primary winding's leakage inductance to the secondary winding before the first switching transistor turns on, and a drain voltage of the first switching transistor is reduced to zero volts by turning off the second GaN switching transistor; and
control the first switching transistor to turn on only when the second GaN switching transistor is turned off and the second signal indicates a fall through zero, thereby enabling the first switching transistor to achieve zero-voltage switching.

Optionally, the operating mode of the flyback converter circuit includes a continuous conduction mode and/or quasi-resonant mode; when the flyback converter circuit operates in the continuous conduction mode or quasi-resonant mode, the switching transistor control unit is configured to:
if the switching frequency clock control signal indicates preparation to control the first switching transistor to turn on, control the second GaN switching transistor to turn on first;
if the switching frequency clock control signal indicates preparation to control the first switching transistor to turn on, and the first signal indicates that a current at the first end of the second GaN switching transistor is less than or equal to a first threshold value, control the second GaN switching transistor to turn off;
if the switching frequency clock control signal indicates preparation to control the first switching transistor to turn on, the second GaN switching transistor is turned off, and the second signal indicates a fall through zero, control the first switching transistor to turn on; and if the switching frequency clock control signal indicates the control to turn off the first switching transistor, control the first switching transistor to turn off.

Optionally, when the flyback converter circuit operates in the continuous conduction mode, the first threshold value corresponding to the first signal is:

$$- \sqrt{\frac{C e}{L l e a k}} ( N \times Vo + Vin )$$

when the flyback converter circuit operates in the quasi-resonant mode, the first threshold value corresponding to the first signal is:

$$- \sqrt{\frac{C e}{L p}} ( N \times Vo + Vin )$$

wherein Ce is an equivalent capacitance from the drain of the first switching transistor to ground, Lleak is the leakage inductance of the primary winding, Lm is a magnetizing inductance of the primary winding, Lp is an inductance value of the primary winding, Lp=Lm+Lleak, N is a turns ratio between the primary winding and the secondary winding, Vo is an output voltage of the secondary-side output circuit, and Vin is an input voltage of the primary-side input circuit.

Optionally, the operating mode of the flyback converter circuit includes a discontinuous current mode (DCM); when the flyback converter circuit operates in DCM, the switching transistor control unit is configured to:
if the switching frequency clock control signal indicates preparation to control the first switching transistor to turn on, and the second signal indicates a rise through zero, control the second GaN switching transistor to turn on and the first switching transistor to turn off;
if the switching frequency clock control signal indicates preparation to control the first switching transistor to turn on, and the first signal indicates that a current at the first end of the second GaN switching transistor is less than or equal to a first threshold value, control the second GaN switching transistor to turn off;
if the second GaN switching transistor is turned off, and the switching frequency clock control signal indicates preparation to control the first switching transistor to turn on, and the second signal indicates a fall through zero, control the first switching transistor to turn on; and
if the switching frequency clock control signal indicates preparation to control the first switching transistor to turn off, control the first switching transistor to turn off.

Optionally, when the flyback converter circuit operates in DCM, the first threshold value corresponding to the first signal is:

$$- \sqrt{\frac{C e}{L p}} ( N \times Vo + Vin )$$

wherein Ce is an equivalent capacitance from the drain of the first switching transistor to ground, Lp is an inductance value of the primary winding, N is a turns ratio between the primary winding and the secondary winding, Vo is an output voltage of the secondary-side output circuit, and Vin is an input voltage of the primary-side input circuit.

Optionally, the second GaN switching transistor is an E-type GaN switching transistor.

Optionally, when the flyback converter circuit operates in the continuous conduction mode, the switching transistor control unit is further configured to:
if the switching frequency clock control signal indicates control to turn off the first switching transistor, and the first signal indicates that the current at the first end of the second GaN switching transistor is greater than or equal to a second threshold value, control the second GaN switching transistor to turn on; and
if the switching frequency clock control signal indicates control to turn off the first switching transistor, and the first signal indicates that the current at the first end of the second GaN switching transistor is zero, control the second GaN switching transistor to turn off.

Optionally, the second GaN switching transistor is a D-type GaN switching transistor or a MOSFET switching transistor.

Optionally, the primary-side input circuit further includes a fourth resistor; and
a first end of the fourth resistor is coupled to the first end of the first switching transistor, and a second end of the fourth resistor is coupled to the first end of the second GaN switching transistor.

Optionally, the first input terminal of the switching transistor control unit receives a voltage across both ends of the fourth resistor.

Optionally, the secondary-side output circuit includes a third switching transistor, a third resistor, a third capacitor, and a third switching transistor control unit;
a first end of the third resistor and a first end of the third capacitor are both coupled to the second end of the secondary winding, a third end of the secondary winding is coupled to a first end of the third switching transistor control unit and a first end of the third switching transistor respectively, an output terminal of the third switching transistor control unit is coupled to a control end of the third switching transistor, and a third end of the third switching transistor control unit is coupled to a second end of the third switching transistor, a second end of the third resistor, and a second end of the third capacitor.

Optionally, the primary-side input circuit further includes a power-side capacitor; and
the second end of the second resistor and the second end of the second capacitor are grounded through the power-side capacitor.

In one aspect, the present application provides an electronic device, including the flyback converter circuit described above.

In the flyback converter circuit and electronic device provided by the present application, the first switching transistor is coupled to the first end of the primary winding and the second GaN switching transistor. The second GaN switching transistor is coupled to the second end of the primary winding via the second resistor connected in parallel. The voltage output from the auxiliary winding is obtained through a series connection of the first and second voltage divider resistors, and the corresponding second signal is transmitted. The switching transistor control unit controls the turn-on and turn-off of the second GaN switching transistor based at least on the switching frequency clock control signal, the first signal, and the operating mode of the flyback converter circuit. In this way, before turning on the first switching transistor, the second GaN switching transistor is turned on to transfer the stored primary leakage inductance energy to the secondary winding. By turning off the second GaN switching transistor, the drain voltage of the first switching transistor is reduced to a few tens of volts or zero volts. And the first switching transistor is then turned on only when the second GaN switching transistor is off and the second signal indicates a fall through zero, enabling the first switching transistor to realize zero-voltage switching (ZVS). Moreover, the second GaN switching transistor has a short reverse recovery time and does not suffer from common issues associated with the reverse recovery period, thereby improving circuit efficiency and reliability.

### BRIEF DESCRIPTION OF THE DRAWINGS

To clearly illustrate the technical solutions of the embodiments of this application and the prior art, the following briefly introduces the accompanying drawings used in the description of the embodiments. Obviously, the drawings in the following description are only some embodiments of this application. For those skilled in the art, other drawings can be obtained based on these drawings without creative effort.

FIG. 1 is a structural schematic diagram of a flyback converter circuit in the prior art of the present application.

FIG. 2 is a first schematic diagram of voltage waveforms in a flyback converter circuit in the prior art of the present application.

FIG. 3 is a second schematic diagram of voltage waveforms in a flyback converter circuit in the prior art of the present application.

FIG. 4 is a first structural schematic diagram of a flyback converter circuit in an embodiment of the present application.

FIG. 5 is a first schematic diagram of voltage waveforms in a flyback converter circuit in an embodiment of the present application.

FIG. 6 is a second structural schematic diagram of a flyback converter circuit in an embodiment of the present application.

FIG. 7 is a second schematic diagram of voltage waveforms in a flyback converter circuit in an embodiment of the present application.

FIG. 8 is a third schematic diagram of voltage waveforms in a flyback converter circuit in an embodiment of the present application.

FIG. 9 is a fourth schematic diagram of voltage waveforms in a flyback converter circuit in an embodiment of the present application.

Reference signs in the drawings are as follows:
11—Switching Transistor Control Unit;
31—Third Switching Transistor Control Unit;
Qm—First Switching Transistor;
Qsn—Second GaN Switching Transistor;
Np—Primary Winding;
Ns—Secondary Winding;
Naux—Auxiliary Winding;
D1—First Diode;
D2—Second Diode;
D3—Third Capacitor
C1—First Capacitor;
C2—Second Capacitor;
C3—Third Capacitor;
R1—First Resistor;
R2—Second Resistor;
R3—Third Resistor;
R4—Fourth Resistor;
Vgs_Qm—Main Switching Transistor Control Signal;
Vgs_Sn—Clamp Switching Transistor Control Signal;
Fsw_Clock—Switching Frequency Clock Control Signal;
Cin—Power-Side Capacitor;
Lleak—Leakage Inductance.

### DETAILED DESCRIPTION OF PREFERRED EMBODIMENTS

The technical solutions in the embodiments of the present application will be clearly and completely described below with reference to the drawings in the embodiments of this application. Obviously, the described embodiments are merely part of the embodiments of this application, not all of them. Based on the embodiments in this application, all other embodiments obtained by those of ordinary skill in the art without creative effort belong to the protection scope of this application.

The terms “first”, “second”, “third”, “forth” and so on (if any) in the specification and claims of this application, as well as the drawings, are intended to identify similar features rather than to define a specific order or sequence. It should be appreciated that the data so used can be interchanged in appropriate conditions, allowing the embodiments described herein to be implemented in different orders than those illustrated or described herein. Furthermore, the terms “comprise” and “include” and their derivatives relate to inclusive or open-ended scope and do not exclude additional, unrecited elements. For example, a process, method, system, product, or equipment that includes a sequence of steps or units is not limited to those specifically specified, but may also include other steps or units that are not explicitly listed or are inherent in such processes, methods, products, or equipment.

The technical solutions of the present application will be described in detail below with reference to specific embodiments. The following specific embodiments can be combined with one another, and the same or similar concepts or processes may not be repeated in some embodiments.

Before filing this application, the applicant conducted thorough research on the flyback converter circuit and based on this research, proposed the flyback converter circuit shown in FIG. 1. For the flyback converter circuit shown in FIG. 1, due to the presence of leakage inductance in the flyback transformer, the heavier the output load, the higher the spike voltage of the leakage inductance, resulting in higher voltage stress on the primary switch, and poorer EMI performance. Furthermore, under QR mode flyback operation, when the input voltage is much greater than N*Vo (i.e., the first output voltage N=Np/Ns), the valley voltage becomes higher, and the main switching transistor experiences significant switching losses.

Specifically, refer to FIG. 1, which includes the following components: a primary-side input circuit, a transformer, a secondary-side output circuit, an auxiliary winding circuit, an RCD snubber circuit, and a fourth capacitor. The primary-side input circuit includes a switching transistor control unit 11, a first switching transistor Qm, and a fourth resistor R4. The transformer includes a primary winding Np, a secondary winding Ns, and an auxiliary winding Naux. The secondary-side output circuit includes a first diode D1, a third capacitor C3, and a third resistor R3. The auxiliary winding circuit includes a second diode D2, a first capacitor C1, and a first resistor R1. The RCD snubber circuit includes a second resistor R2, a second capacitor C2, and a third capacitor D3.

In this configuration, the output terminal of the switching transistor control unit 11 is connected to the control terminal of the first switching transistor Qm. The first end of the first switching transistor Qm is connected to both the first end of the primary winding Np and the anode of the third capacitor D3. That is, the second end of the first switching transistor Qm is connected to the first end of the fourth resistor R4, and the second end of the fourth resistor R4 is grounded. The cathode of the third capacitor D3 is connected to both the first end of the second resistor R2 and the first end of the second capacitor C2, and the second end of the second resistor R2 and the second end of the second capacitor C2 are both connected to the second end of the primary winding Np.

The secondary winding Ns is connected to the secondary-side output circuit, and the second end of the secondary-side output circuit is used to output a first output voltage. The first end of the secondary winding Ns is connected via the first diode D1 to both the first end of the third capacitor C3 and the first end of the third resistor R3. The second end of the third capacitor C3 and the second end of the third resistor R3 are both connected to the second end of the secondary winding Ns.

The auxiliary winding Naux is connected to the auxiliary winding circuit, and the second end of the auxiliary winding is used to output a second output voltage (Vcc in FIG. 1). The first end of the auxiliary winding Naux is connected via the second diode D2 to the first end of the first capacitor C1 and the first end of the first resistor R1. The second end of the first capacitor C1 and the second end of the first resistor R1 are both connected to the second end of the auxiliary winding Naux.

In the above scheme, when the circuit operates, the heavier the total output load, the higher the peak voltage caused by the leakage inductance in the circuit. This results in increased voltage stress on the primary switch and EMI issues. Additionally, in conventional flyback circuits, when the primary switch turns on, there is significant capacitive turn-on loss. Even in QR mode flyback, when the input voltage exceeds N*Vo by a considerable amount, the valley voltage is high, leading to considerable turn-on loss in the primary switch.

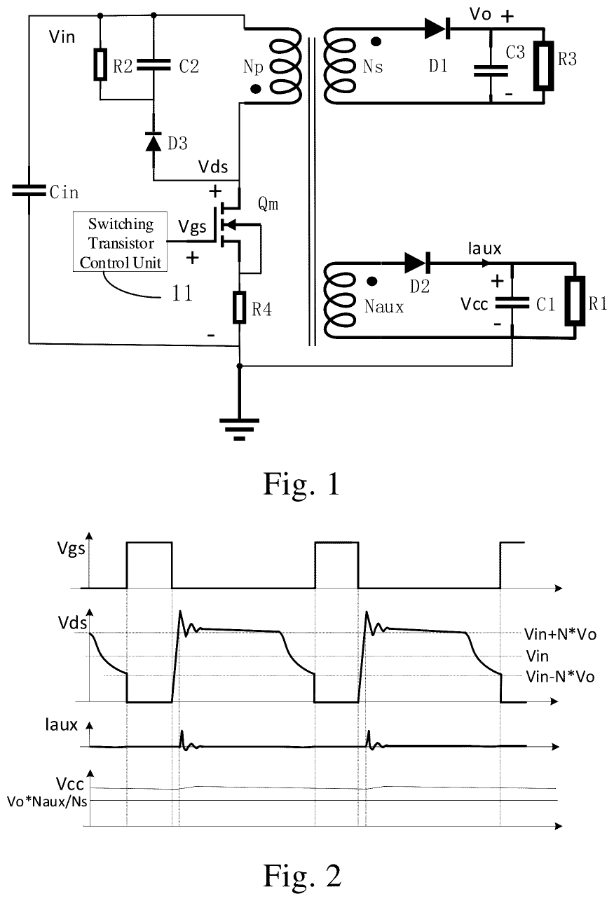

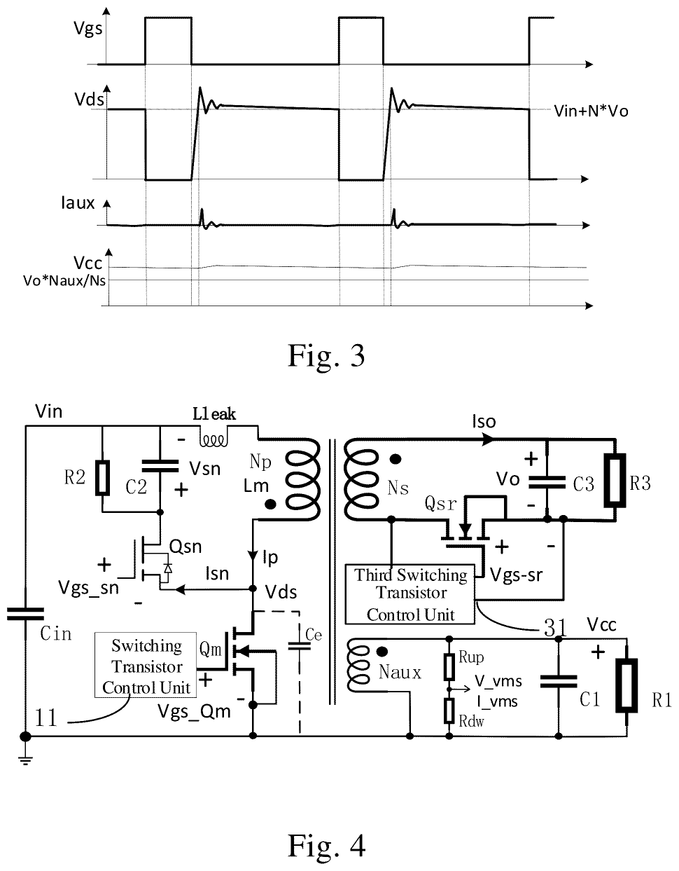

Specifically, please refer to FIG. 2 and FIG. 3, which show the key waveforms of QR mode and CCM mode in conventional flyback circuits, respectively. From these figures, it is evident that the second output voltage Vcc is always greater than the first output voltage Vo*Naux/Ns, and in QR mode, the valley conduction voltage is relatively high.

To address the aforementioned issues, the prior art adopts the following solution: a complementary auxiliary MOS switch is added on the primary side of the circuit, which operates in complement to the main switch. This auxiliary MOS switch is connected in series with a clamp capacitor, replacing the original RCD snubber circuit. The auxiliary MOS switch is configured to turn on for a fixed period before the main switching transistor turns on, so that when the main switching transistor turns off, the energy of the leakage inductance is first absorbed into a clamp capacitor, and then released to the load or input terminal. However, this approach results in the time required to turn the auxiliary MOS switch on and off being a large fixed value, which will lead to a large effective current value of the auxiliary MOS switch and a large conduction loss, reducing the efficiency of the circuit. Moreover, due to the long reverse recovery time of the body diode of the auxiliary MOS and the large reverse recovery current (the reverse recovery time and current being much larger than that of GaN), there is a common risk associated with reverse recovery during CCM (Continuous Conduction Mode) operation, which reduces the reliability of the circuit.

To address this, the present application proposes a new flyback converter circuit in which the first switching transistor Qm is respectively coupled to the first end of the primary winding Np and the second GaN switching transistor Qsn. The second GaN switching transistor Qsn is connected to the second end of the primary winding Np through the second resistors R2 connected in parallel. The circuit also includes a series arrangement of a first voltage divider resistor Rup and a second voltage divider resistor Rdw to obtain the voltage output from the auxiliary winding Naux and to transmit the corresponding second signal. The switching transistor control unit 11 controls the turn-on and turn-off of the second GaN switching transistor Qsn based at least on the switching frequency clock control signal Fsw_Clock, the first signal, and the operating mode of the flyback converter circuit. In this way, before the first switching transistor Qm turns on, the second GaN switching transistor Qsn turns on to transfer the energy of the leakage inductance Lleak of the primary winding Np to the secondary winding Ns. The voltage at the drain of the first switching transistor Qm is reduced to zero volts by turning off the second GaN switching transistor Qsn. The first switching transistor Qm is controlled to turn on only when the second GaN switching transistor Qsn is off and the second signal indicates a fall through zero, enabling zero-voltage switching for the first switching transistor Qm. Moreover, the reverse recovery time of the second GaN switching transistor Qsn is extremely short, eliminating the common issues during reverse recovery and improving the circuit's efficiency and reliability.

The solution of the present application is specifically described as follows.

With reference to FIG. 4, the present application provides a flyback converter circuit, including: a primary-side input circuit, a transformer, a secondary-side output circuit, and an auxiliary winding circuit. The primary-side input circuit includes a switching transistor control unit 11, a first switching transistor Qm, and an absorption module. The auxiliary winding circuit includes a first voltage divider resistor Rup, a second voltage divider resistor Rdw, a first capacitor C1, and a first resistor R1. The absorption module includes a second resistor R2, a second capacitor C2, and a second GaN switching transistor Qsn.

The first input terminal of the switching transistor control unit 11 receives the first signal, and its second input terminal receives the switching frequency clock control signal Fsw_Clock (not shown in the figure). Its output terminal is coupled to the control terminal of the first switching transistor Qm to output the main switching transistor control signal Vgs_Qm. The output terminal is also coupled to the control terminal of the second GaN switching transistor Qsn to output the clamp switching transistor control signal Vgs_sn. The first end of the first switching transistor Qm is connected to both the first end of the primary winding Np and the first end of the second GaN switching transistor Qsn, and the second end of the first switching transistor Qm is grounded. The second end of the second GaN switching transistor Qsn is connected to both the first end of the second resistor R2 and the first end of the second capacitor C2. The second ends of the second resistor R2 and the second capacitor C2 are connected to the second end of the primary winding Np. The first signal includes the current Isn flowing through the first end of the second GaN switching transistor Qsn. In other examples, the first signal may also include the voltage information of the first end of the second GaN switching transistor Qsn.

The first end of the auxiliary winding Naux is respectively coupled to the first end of the first voltage divider resistor Rup and the first end of the first capacitor C1. The second end of the first voltage divider resistor Rup is coupled to the first end of the second voltage divider resistor Rdw and is also coupled to the third input terminal of the switching transistor control unit 11 (not shown in the figure), to output a second signal. The second end of the second voltage divider resistor Rdw is coupled to the second end of the auxiliary winding Naux and the second end of the first capacitor C1. The first resistor R1 is connected in parallel with the first capacitor C1. The second signal includes the current value I_vms flowing through the first voltage divider resistor Rup or the voltage value V_vms at the second end of the first voltage divider resistor Rup.

In the example of FIG. 4, the second end of the auxiliary winding Naux is also grounded.

The first and second ends of the secondary winding Ns are respectively coupled to the first and second ends of the secondary-side output circuit.

The switching transistor control unit 11 is configured to: based at least on the switching frequency clock control signal Fsw_Clock, the first signal, and the operating mode of the flyback converter circuit, control the second GaN switching transistor Qsn to turn on and off. In this way, before the first switching transistor Qm turns on, the second GaN switching transistor Qsn transmits the stored energy of the leakage inductance Lleak of the primary winding Np to the secondary winding Ns. By turning off the second GaN switching transistor Qsn, the drain voltage of the first switching transistor Qm is reduced to zero volts. In practical operation, reducing the drain voltage of the first switching transistor Qm to a few tens of volts may also meet the application requirements.

The first switching transistor Qm is controlled to turne on only when the second GaN switching transistor Qsn turns off, and the second signal indicates a fall through zero, thereby enabling the first switching transistor Qm to achieve zero-voltage switching.

In other embodiments, referring to FIG. 4, the primary-side input circuit further includes a power-side capacitor Cin; and the second end of the second resistor R2 and the second end of the second capacitor C2 are also grounded through the power-side capacitor Cin.

In a specific embodiment, the switching transistor control unit 11 may further receive a switching frequency clock control signal to control the turn-off of the first switching transistor Qm.

Based on this, in one embodiment, the operating modes of the flyback converter circuit include Continuous Conduction Mode (CCM), Quasi-Resonant Mode (QR), and Discontinuous Conduction Mode (DCM). Compared to the traditional RCD absorption flyback circuit, the circuit structure of the present application replaces the RCD absorption circuit with a second resistor R2, a second capacitor C2, and a second GaN switching transistor Qsn.

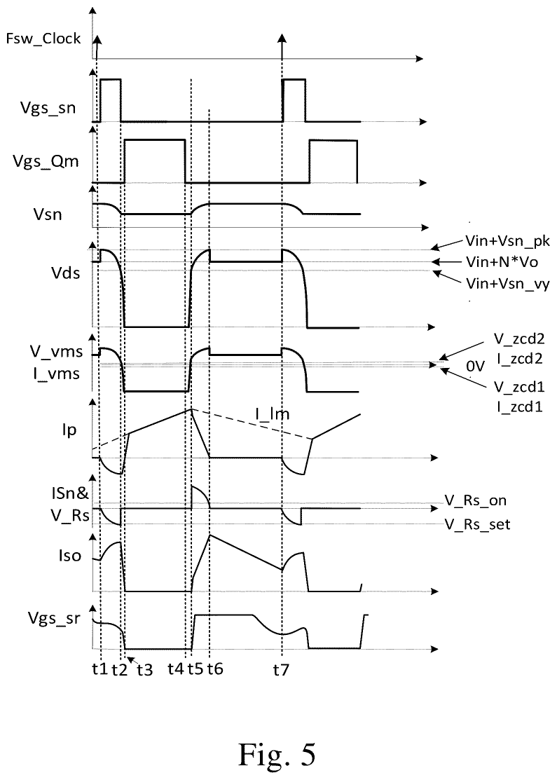

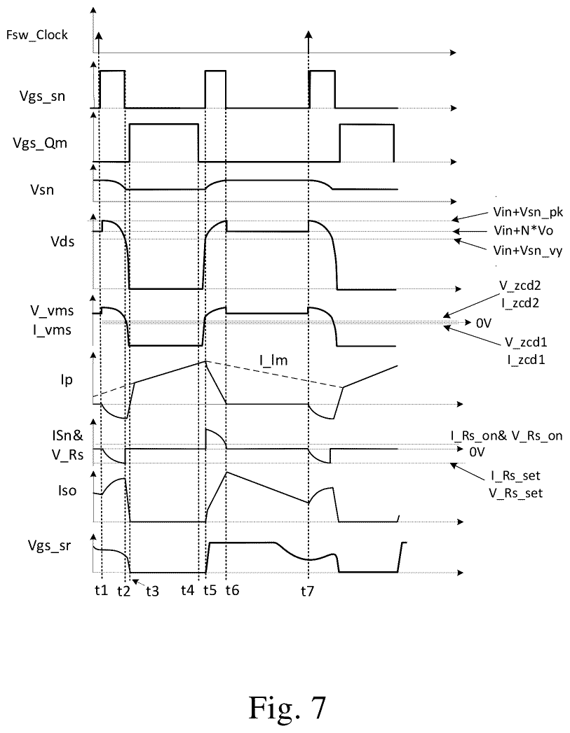

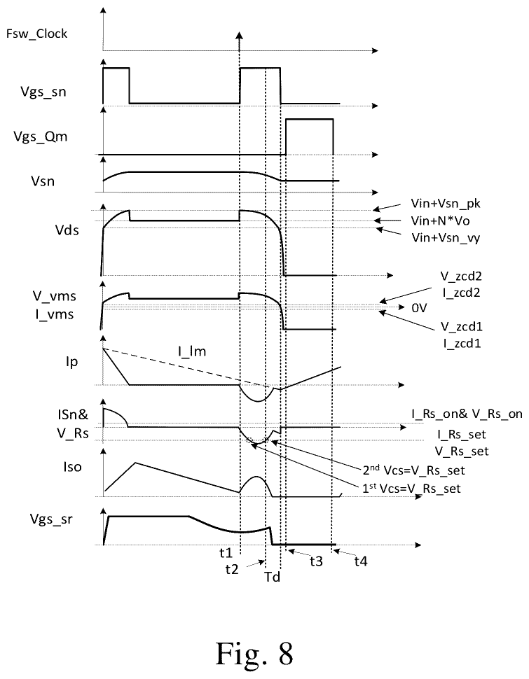

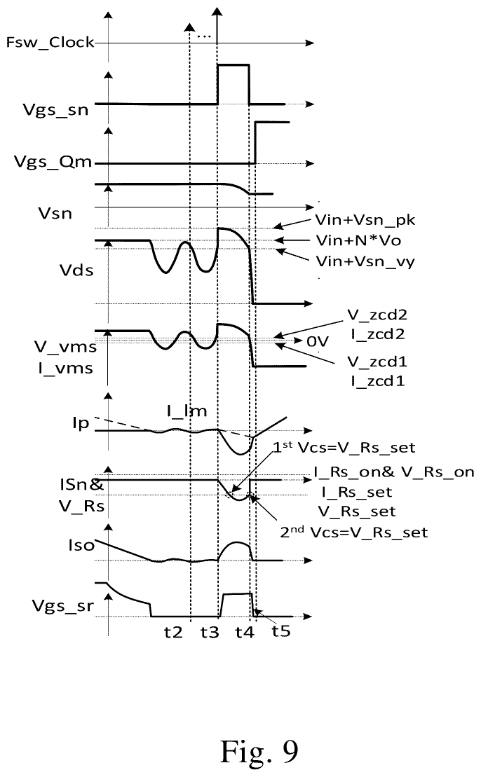

Regarding the control process of the flyback converter circuit, in a preferred embodiment, please refer to FIG. 5, FIG. 7, FIG. 8, and FIG. 9. FIG. 5 and FIG. 7 show the operating waveforms in CCM mode, FIG. 8 shows the operating waveform in QR mode, and FIG. 9 shows the operating waveform in DCM mode.

The CCM mode operating waveform in FIG. 5 and FIG. 4 are described as follows.

At time t1, the switching frequency clock control signal Fsw_Clock indicates preparation to control the first switching transistor Qm to turn on. Therefore, the control signal Vgs_sn is set to a high level, i.e., the second GaN switching transistor Qsn is controlled to be turned on. Since, at this moment, the voltage drop across the second GaN switching transistor Qsn, VVsn−N*Vo, is greater than 0 (where N=Np/Ns and Vo is the output voltage of the secondary-side output circuit), there is turn-on loss. However, since the Coss capacitance of the GaN transistor is relatively small, using a GaN switching transistor as the clamp transistor helps reduce turn-on losses.

Additionally, since the excitation current in the circuit is not zero in CCM mode, the secondary winding Ns remains in conduction state. The inductance Lm of the primary winding Np is clamped by N*Vo. The second capacitor C2 resonates with the leakage inductance Lleak of the primary winding Np. The second capacitor C2 transfers the energy absorbed from the leakage inductance to the leakage inductance Lleak of the primary winding Np and the secondary winding Ns. The current generated by the resonance forms a loop in the secondary winding Ns through the current Iso flowing through the secondary winding Ns.

At time t2, the current Isn flowing through the first end of the second GaN switching transistor Qsn becomes less than or equal to the first threshold I_Rs_set, meaning that the first signal characterizes the current Isn at the first end of the second GaN switching transistor Qsn as being less than or equal to I_Rs_set. As a result, the second GaN switching transistor Qsn is turned off.

At this point, the voltage across the second capacitor C2, denoted as Vsn, reaches the valley voltage Vsn_vy. The leakage inductance Lleak of the primary winding Np resonates with the equivalent capacitance Ce from the drain of the first switching transistor Qm to ground. The current flowing through the leakage inductance Lleak of the primary winding Np is equal to the current Isn flowing through the first end of the second GaN switching transistor Qsn. Generally, the absolute value of the current through the leakage inductance Lleak of the primary winding Np is set to be greater than (Vin+N1*Vo)*(Ce/Lleak)^{1/2}, where Ce is the equivalent capacitance from the drain of the first switching transistor Qm to ground, Lleak is the leakage inductance of the primary winding Np, N is the turns ratio between the primary winding Np and secondary winding Ns (Np/Ns), Vo is the output voltage of the secondary-side output circuit, and Vin is the input voltage of the primary-side input circuit. The current through the leakage inductance Lleak of the primary winding Np flows in a negative direction (i.e., toward the power-side capacitor Cin), which enables the drain voltage of the first switching transistor Qm to lower to several tens of volts or even zero.

At time t3, when the voltage V_vms at the second end of the first voltage divider resistor Rup or the current I_vms through the first voltage divider resistor Rup is detected to drop below zero, i.e., the second signal indicates a fall through zero, the first switching transistor Qm is controlled to turn on. At this point, the drain voltage Vds of the first switching transistor Qm has resonated to 0V or nearly 0V, achieving Zero Voltage Switching (ZVS).

At time t4, the switching frequency clock control signal indicates control of turning off of the first switching transistor Qm, then the first switching transistor Qm is controlled to turn off. The voltage Vds across the first switching transistor Qm begins to rise.

The above describes the operation of a switching cycle (t1-t4) when the second GaN switching transistor Qsn is a D-type GaN switching transistor or MOS transistor. The waveform repeats the t1-t4 cycle with the arrival of the next switching frequency clock control signal Fsw_Clock for the subsequent switching cycle. This is because the voltage drop Vsd_on of D-type GaN switching transistor is very low, allowing for conduction without the need for additional switch control.

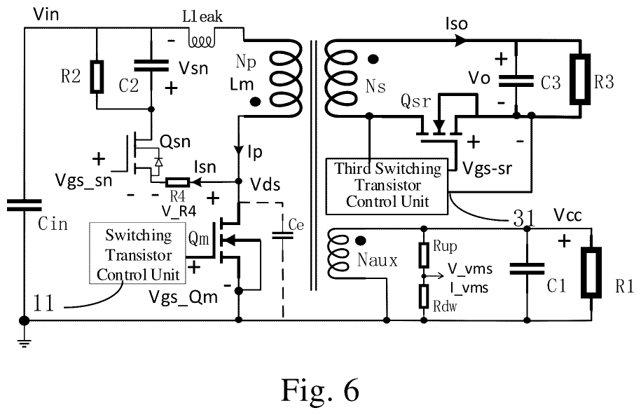

Please refer to FIG. 6. In the case where the second GaN switching transistor Qsn is an E-type GaN switching transistor, after time t4, the second GaN switching transistor Qsn needs to be turned on again. Specifically, refer to the CCM mode working waveforms shown in FIG. 7:

the working waveforms from time t1 to t4 are similar to those in FIG. 5, so they will not be repeated here.

At time t5, the voltage across the first switching transistor Qm (Vds) rises to greater than Vin+Vsn_vy+Vsd(on), at which point the second GaN switching transistor Qsn begins to turn on. During this time, the current flowing through the second GaN switching transistor Qsn is forward current. To reduce the voltage drop Vsd of the second GaN switching transistor Qsn, when the first signal indicates that the current Isn or voltage at the first end of the second GaN switching transistor Qsn is greater than or equal to a second threshold value I_Rs_on or V_Rs_on, the second GaN switching transistor Qsn is controlled to turn on.

At time t6, the voltage Vds at both ends of the first switching transistor Qm is equal to Vin+Vsn_pk, that is, it reaches the second peak point, and the current Isn flowing through the first end of the second GaN switching transistor Qsn is equal to 0 or close to zero, then the second GaN switching transistor Qsn is controlled to turn off.

The operation from time t1 to time t6, in the case where the second GaN switching transistor Qsn is an E-type GaN switch, completes one switching cycle. In the next cycle, at the arrival of the next switching frequency clock control signal Fsw_Clock (at time t7), the waveform repeats from time t1 to time t6 for the next operation.

The controller can automatically adjust the first threshold value I_Rs_set or V_Rs_set based on the input voltage, output voltage information, and the pre-set values of Ce/Lleak and Ce/Lp.

In one embodiment, for the CCM mode, the first threshold value I_Rs_set is:

$$- \sqrt{\frac{C e}{L l e a k}} ( N \times Vo + Vin )$$

wherein Ce is an equivalent capacitance from the drain of the first switching transistor to ground, Lleak is the leakage inductance Lleak of the primary winding Np, N is a turns ratio between the primary winding and the secondary winding, Vo is an output voltage of the secondary-side output circuit, and Vin is an input voltage of the primary-side input circuit.

When the second GaN switching transistor Qsn is an E-type GaN switch, for the QR mode waveforms shown in FIG. 8, specifically:

at time t1, the switching frequency clock control signal Fsw_Clock indicates preparation of control to turn on the first switching transistor Qm, then the Vgs_sn is controlled to be a high level, thereby turning on the second GaN switching transistor Qsn.

The second capacitor C2 resonates with the leakage inductance Lleak of the primary winding Np, the second capacitor C2 transfers the absorbed leakage inductance energy to the leakage inductance Lleak of primary winding Np and the secondary winding Ns. The current generated by resonance flows through the secondary winding Ns. Subsequently, the transformer's magnetizing current drops to zero and begins to reverse magnetization. Since the current generated by the resonance between Csn and Lleak exceeds the magnetizing current I_Lm, this resonance current forms a loop in the secondary winding Ns, with the current Iso.

At time t2, when the current Isn or voltage at the first end of the second GaN switching transistor Qsn is less than or equal to the first threshold value I_Rs_set or V_Rs_set, i.e., the first signal indicates that the current Isn or voltage at the first end of the second GaN switching transistor Qsn is less than or equal to the first threshold value I_Rs_set or V_Rs_set, the second GaN switching transistor Qsn is controlled to turn off.

As a preferred embodiment, the second GaN switching transistor can be controlled to turn off whenever the current or voltage at the first end of the second switching transistor becomes less than or equal to the first threshold value I_Rs_set or V_Rs_set.

In other embodiments, the number of times the current or voltage at the first end of the second switching transistor is less than or equal to the first threshold value I_Rs_set or V_Rs_set can be defined. The second switching transistor can be turned off on the n-th occurrence of the current or voltage at the first end being less than or equal to the first threshold value I_Rs_set or V_Rs_set, so as to proceed with the next steps, where n is an integer greater than or equal to 1.

In other preferred embodiments, after the current or voltage at the first end of the second switching transistor becomes less than or equal to the first threshold value I_Rs_set or V_Rs_set for the n-th time, a set delay time Td may be applied before turning off the second switching transistor. The delay time Td can be greater than or equal to zero.

In the example shown in FIG. 8, after the current or voltage at the first end of the second switching transistor becomes less than or equal to the first threshold value I_Rs_set or V_Rs_set for the second time, a set delay time Td is applied before controlling the second switching transistor to turn off. The leakage inductance Lleak of the primary winding Np and the equivalent capacitance Ce of the first switching transistor Qm from the drain to ground begin to resonate, and the voltage at the first end of the first switching transistor Qm starts to decrease.

At time t3, when the voltage value V_vms at the second end of the first voltage divider resistor Rup or the current value I_vms through the first voltage divider resistor Rup is detected to drop below zero, i.e., when the second signal indicates a fall through zero, the first switching transistor Qm will be turned on. At this point, the voltage Vds across the first switching transistor Qm will have resonated to 0V or approximately 0V, achieving Zero Voltage Switching (ZVS).

At time t4, the switching frequency clock control signal indicates control of turning off of the first switching transistor Qm, and the first switching transistor Qm will be turned off. The voltage Vds across the first switching transistor Qm will start to rise.

Similarly, when the second GaN switching transistor Qsn is a D-type GaN switch, additional switching control is not required to achieve conduction.

For the DCM (Discontinuous Conduction Mode) working waveform shown in FIG. 9, specifically:
the circuit can determine that the circuit works in DCM state by detecting the current flowing through the first switching transistor Qm or the voltage V_vms or current I_vms.

At time t1, the switching frequency clock control signal Fsw_Clock indicates preparation to control the first switching transistor Qm to turn on.

At time t2, to reduce the switching loss of Qsn, when the voltage V_vms or current I_vms increases and crosses zero (i.e., the second signal indicates a rise through zero), the second GaN switching transistor Qsn is controlled to turn on.

At time t3, when the current Isn or voltage at the first end of the second GaN switching transistor Qsn is less than or equal to the first threshold value I_Rs_set or V_Rs_set, i.e., when the first signal indicates that the current Isn or voltage at the first end of the second GaN switching transistor Qsn is less than or equal to the first threshold value I_Rs_set or V_Rs_set, the second GaN switching transistor Qsn will be controlled to turn off.

As a preferred embodiment, the second switch may be turned off when the current or voltage at the first end of the second switch falls below or equals the first threshold value I_Rs_set or V_Rs_set for the n-th time, where n is an integer greater than or equal to 1.

In other preferred embodiments, the second switch may be turned off after the current or voltage at the first end of the second switch falls below or equals I_Rs_set or V_Rs_set for the n-th time, followed by a delay time Td before turning off the second switch, where Td is greater than or equal to 0.

At time t3, when the voltage value V_vms or the current value I_vms of the second end of the first voltage divider resistor drops below zero, i.e., when the second signal indicates a fall through zero, the first switching transistor Qm is controlled to turn on. At this point, the voltage across the first switching transistor Qm has resonated to 0V or close to 0V, achieving ZVS (Zero Voltage Switching).

At time t4, the switching frequency clock control signal indicates control to turn off the first switching transistor Qm, and the first switching transistor Qm is controlled to turn off. The voltage across the first switching transistor Qm begins to rise.

In one embodiment, in both QR mode and DCM mode, the first signal corresponds to the first threshold value I_Rs_set is:

$$- \sqrt{\frac{C e}{L p}} ( N \times Vo + Vin )$$

where Ce is the equivalent capacitance from the drain of the first switching transistor Qm to the ground, Lm is the inductance of the primary winding, Lp is the inductance of the primary winding Np, with Lp=Lm+Lleak, and N is the turns ratio between the primary winding Np and the secondary winding Ns. Vo is the output voltage of the secondary side output circuit, and Vin is the input voltage of the primary side input circuit.

In a preferred embodiment, to more conveniently obtain the current information flowing through the first end of the second GaN switching transistor Qsn, please refer to FIG. 6. The primary side input circuit further includes a fourth resistor R4.

The first end of the fourth resistor R4 is coupled to the first end of the first switching transistor Qm, and the second end is coupled to the first end of the second GaN switching transistor Qsn.

In this case, the first input terminal of the switching transistor control unit 11 receives the voltage across the fourth resistor R4, V_R4=V_Rs_set. That is, the first signal also includes the voltage value across the two terminals of the fourth resistor.

In this case, the first signal indicates that the current Isn or voltage at the first end of the second GaN switching transistor Qsn is greater than or equal to the second threshold value V_Rs_on, the second GaN switching transistor Qsn is controlled to turn on. This can also be understood as: when the first signal indicates that the voltage across the fourth resistor R4 is greater than or equal to the second threshold value V_Rs_on, the second GaN switching transistor Qsn is controlled to turn on.

Similarly, the first signal indicates that the current Isn at the first end of the second GaN switching transistor Qsn is less than or equal to the first threshold value I_Rs_set, the second GaN switching transistor Qsn is controlled to turn off. This can also be understood as: when the first signal indicates that the voltage V_R4=Isn*R4 across the fourth resistor R4 is less than or equal to the first threshold value V_Rs_set, the second GaN switching transistor Qsn is controlled to turn off.

In other embodiments, please refer to FIG. 4. The secondary side output circuit includes a third switching transistor Qsr, a third resistor R3, a third capacitor C3, and a third switching transistor control unit 31.

The first end of the third resistor R3 and the first end of the third capacitor C3 are both coupled to the second end of the secondary winding Ns, and the third end of the secondary winding Ns is respectively coupled to the first end of the third switching transistor control unit 31 and the first end of the third switching transistor Qsr. The output terminal of the third switching transistor control unit 31 is coupled to the control terminal of the third switching transistor Qsr, and the third end of the third switching transistor control unit 31 is coupled to the second end of the third switching transistor Qsr, the second end of the third resistor R3, and the second end of the third capacitor C3.

Of course, the present application is not limited to this, and other components or combinations of components that can achieve secondary side output are within the scope of the present application.

The control method proposed by the present application can also be applied when the clamp transistor Qsn is a MOS transistor. When Qsn is a MOS transistor, if its control method is the same as the D-MODE GaN control method proposed by the present application, it is also within the scope of the present application.

Additionally, the present application also provides an electronic device, which includes the above-described flyback converter circuit. For example, the device could be a charging plug, among others, but the scope of the invention is not limited to these examples.

In summary, according to the embodiments of the present application, the first switching transistor is coupled to the first end of the primary winding and the second GaN switching transistor. The second GaN switching transistor is coupled to the second end of the primary winding via the second resistor connected in parallel. The voltage output from the auxiliary winding is obtained through a series connection of the first and second voltage divider resistors, and the corresponding second signal is transmitted. The switching transistor control unit controls the turn-on and turn-off of the second GaN switching transistor based at least on the switching frequency clock control signal, the first signal, and the operating mode of the flyback converter circuit. In this way, before turning on the first switching transistor, the second GaN switching transistor is turned on to transfer the stored primary leakage inductance energy to the secondary winding. By turning off the second GaN switching transistor, the drain voltage of the first switching transistor is reduced to a few tens of volts or zero volts. And the first switching transistor is then turned on only when the second GaN switching transistor is off and the second signal indicates a fall through zero, enabling the first switching transistor to realize zero-voltage switching (ZVS). Moreover, the second GaN switching transistor has a short reverse recovery time and does not suffer from common issues associated with the reverse recovery period, thereby improving circuit efficiency and reliability.

Finally, it should be emphasized that the above embodiments are intended to illustrate the technical solutions of the present application, not to limit it. While the application has been described in detail with reference to the specific embodiments, those skilled in the art will appreciate that modifications may be made to the described technical solutions, or that certain technical features may be substituted with equivalent alternatives. Such modifications or substitutions do not alter the essence of the application and are still within the scope of the technical solutions outlined in the embodiments of the present application.

What is claimed is:

1. A flyback converter circuit, comprising: a primary-side input circuit, a transformer, a secondary-side output circuit, and an auxiliary winding circuit; wherein the primary-side input circuit comprises a switching transistor control unit, a first switching transistor, and an absorption module; the auxiliary winding circuit comprises a first voltage divider resistor, a second voltage divider resistor, a first capacitor, and a first resistor; the absorption module comprises a second resistor, a second capacitor, and a second GaN (gallium nitride) switching transistor;
a first input terminal of the switching transistor control unit receives a first signal, a second input terminal receives a switching frequency clock control signal, and an output terminal is coupled to a control terminal of the first switching transistor and a control terminal of the second GaN switching transistor, respectively; a first end of the first switching transistor is coupled to both a first end of the primary winding and a first end of the second GaN switching transistor, while a second end of the second GaN switching transistor is coupled to both a first end of the second resistor and a first end of the second capacitor; a second end of the second resistor and a second end of the second capacitor are coupled to a second end of the primary winding; wherein the first signal comprises current information flowing through the first end of the second GaN switching transistor;
a first end of the auxiliary winding is coupled to both a first end of the first voltage divider resistor and a first end of the first capacitor; a second end of the first voltage divider resistor is coupled to a first end of the second voltage divider resistor, and the second end of the first voltage divider resistor is also coupled to the a input end of the switching transistor control unit to output a second signal; a second end of the second voltage divider resistor is coupled to both a second end of the auxiliary winding and a second end of the first capacitor, and the first resistor is connected in parallel with the first capacitor; wherein the second signal comprises a current value flowing through the first voltage divider resistor or a voltage value at the second end of the first voltage divider resistor;
a first end and a second end of the secondary winding are coupled to a first end and a second end of the secondary-side output circuit, respectively;
wherein the switching transistor control unit is configured to:
control the turning on and off of the second GaN switching transistor based at least on the switching frequency clock control signal, the first signal, and an operating mode of the flyback converter circuit, so as to transfer stored energy of the primary winding's leakage inductance to the secondary winding before the first switching transistor turns on, and a drain voltage of the first switching transistor is reduced to zero volts by turning off the second GaN switching transistor; and
control the first switching transistor to turn on only when the second GaN switching transistor is turned off and the second signal indicates a fall through zero, thereby enabling the first switching transistor to achieve zero-voltage switching.

2. The flyback converter circuit of claim 1, wherein the operating mode of the flyback converter circuit comprises a continuous conduction mode and/or quasi-resonant mode; when the flyback converter circuit operates in the continuous conduction mode or quasi-resonant mode, the switching transistor control unit is configured to:
if the switching frequency clock control signal indicates preparation to control the first switching transistor to turn on, control the second GaN switching transistor to turn on first;
if the switching frequency clock control signal indicates preparation to control the first switching transistor to turn on, and the first signal indicates that a current at the first end of the second GaN switching transistor is less than or equal to a first threshold value, control the second GaN switching transistor to turn off;
if the switching frequency clock control signal indicates preparation to control the first switching transistor to turn on, the second GaN switching transistor is turned off, and the second signal indicates a fall through zero, control the first switching transistor to turn on; and
if the switching frequency clock control signal indicates the control to turn off the first switching transistor, control the first switching transistor to turn off.

3. The flyback converter circuit of claim 2, wherein when the flyback converter circuit operates in the continuous conduction mode, the first threshold value corresponding to the first signal is:
$$- \sqrt{\frac{C e}{L l e a k}} ( N \times Vo + Vin )$$
when the flyback converter circuit operates in the quasi-resonant mode, the first threshold value corresponding to the first signal is:
$$- \sqrt{\frac{C e}{L p}} ( N \times Vo + Vin )$$
wherein Ce is an equivalent capacitance from the drain of the first switching transistor to ground, Lleak is the leakage inductance of the primary winding, Lm is a magnetizing inductance of the primary winding, Lp is an inductance value of the primary winding, Lp=Lm+Lleak, N is a turns ratio between the primary winding and the secondary winding, Vo is an output voltage of the secondary-side output circuit, and Vin is an input voltage of the primary-side input circuit.

4. The flyback converter circuit of claim 1, wherein the operating mode of the flyback converter circuit comprises a discontinuous current mode (DCM); when the flyback converter circuit operates in DCM, the switching transistor control unit is configured to:
if the switching frequency clock control signal indicates preparation to control the first switching transistor to turn on, and the second signal indicates a rise through zero, control the second GaN switching transistor to turn on and the first switching transistor to turn off;
if the switching frequency clock control signal indicates preparation to control the first switching transistor to turn on, and the first signal indicates that a current at the first end of the second GaN switching transistor is less than or equal to a first threshold value, control the second GaN switching transistor to turn off;
if the second GaN switching transistor is turned off, and the switching frequency clock control signal indicates preparation to control the first switching transistor to turn on, and the second signal indicates a fall through zero, control the first switching transistor to turn on; and
if the switching frequency clock control signal indicates preparation to control the first switching transistor to turn off, control the first switching transistor to turn off.

5. The flyback converter circuit of claim 4, wherein when the flyback converter circuit operates in DCM, the first threshold value corresponding to the first signal is:
$$- \sqrt{\frac{C e}{L p}} ( N \times Vo + Vin )$$
wherein Ce is an equivalent capacitance from the drain of the first switching transistor to ground, Lp is an inductance value of the primary winding, N is a turns ratio between the primary winding and the secondary winding, Vo is an output voltage of the secondary-side output circuit, and Vin is an input voltage of the primary-side input circuit.

6. The flyback converter circuit of claim 2, wherein the second GaN switching transistor is an E-type GaN switching transistor.

7. The flyback converter circuit of claim 6, wherein when the flyback converter circuit operates in the continuous conduction mode, the switching transistor control unit is further configured to:
if the switching frequency clock control signal indicates control to turn off the first switching transistor, and the first signal indicates that the current at the first end of the second GaN switching transistor is greater than or equal to a second threshold value, control the second GaN switching transistor to turn on; and
if the switching frequency clock control signal indicates control to turn off the first switching transistor, and the first signal indicates that the current at the first end of the second GaN switching transistor is zero, control the second GaN switching transistor to turn off.

8. The flyback converter circuit of claim 2, wherein the second GaN switching transistor is a D-type GaN switching transistor or a MOSFET switching transistor.

9. The flyback converter circuit of claim 1, wherein the primary-side input circuit further comprises a fourth resistor; and
a first end of the fourth resistor is coupled to the first end of the first switching transistor, and a second end of the fourth resistor is coupled to the first end of the second GaN switching transistor.

10. The flyback converter circuit of claim 9, wherein the first input terminal of the switching transistor control unit receives a voltage across both ends of the fourth resistor.

11. The flyback converter circuit of claim 1, wherein the secondary-side output circuit comprises a third switching transistor, a third resistor, a third capacitor, and a third switching transistor control unit;
a first end of the third resistor and a first end of the third capacitor are both coupled to the second end of the secondary winding, a third end of the secondary winding is coupled to a first end of the third switching transistor control unit and a first end of the third switching transistor respectively, an output terminal of the third switching transistor control unit is coupled to a control end of the third switching transistor, and a third end of the third switching transistor control unit is coupled to a second end of the third switching transistor, a second end of the third resistor, and a second end of the third capacitor.

12. The flyback converter circuit of claim 1, wherein the primary-side input circuit further comprises a power-side capacitor, and
the second end of the second resistor and the second end of the second capacitor are grounded through the power-side capacitor.

13. The flyback converter circuit of claim 4, wherein the second GaN switching transistor is an E-type GaN switching transistor.

14. The flyback converter circuit of claim 4, wherein the second GaN switching transistor is a D-type GaN switching transistor or a MOSFET switching transistor.
